(19) United States
(12) Patent Application Publication
(10) Pub. No.: US 2016/0368415 A1
(43) Pub. Date: Dec. 22, 2016

(54) TANDEM MASTER CYLINDER EQUIPPED WITH A STOPLIGHT SWITCH

(71) Applicant: Robert Bosch GmbH, Stuttgart (DE)

(72) Inventor: Masaki Shiwa, Paris (FR)

(21) Appl. No.: 15/187,313

(22) Filed: Jun. 20, 2016

(30) Foreign Application Priority Data
Jun. 22, 2015 (FR) 1555715

(51) Int. Cl. B60Q 1/44; B60T 11/20

(52) U.S. Cl. CPC B60Q 1/44; B60T 11/20

(57) ABSTRACT

Master cylinder having a housing equipped with a borehole accommodating a primary piston. The housing, equipped with a stoplight control, has, on the one hand, a drill hole whose axis is parallel to that of the borehole accommodating the piston and accommodating a magnet whose movement is coupled to that of the piston and, on the other hand, a Hall sensor, which detects the movement of the magnet for controlling the stoplights. The stoplight control comprises a moving assembly translationally integral with the primary piston at its extremity and having a bracket movably affixed to the end of the piston exiting the housing and a rod whose axis is parallel to the axis of the drill hole, connected to a foot of the bracket and whose extremity, engaged in the drill hole, bears a magnet that cooperates with the Hall sensor.

### CROSS REFERENCE

The present application claims the benefit under 35 U.S.C. §119 of France Patent Application No. FR 1555715 filed on Jun. 22, 2015, which is expressly incorporated herein by reference in its entirety.

### FIELD

The present invention relates to a master cylinder having a housing equipped with a borehole accommodating a primary piston extending beyond the borehole, the housing being equipped with a stoplight control having a drill hole whose axis is parallel to that of the borehole accommodating the piston, where the drill hole accommodates a magnet whose movement is coupled to that of the piston, and a Hall sensor outside the housing, detecting the movement of the magnet to control the stoplights.

### BACKGROUND INFORMATION

A conventional tandem master cylinder is equipped with a stoplight switch consisting of a magnet sliding in a drill hole of the housing of a master cylinder and whose axis is parallel to the master cylinder borehole in which the primary piston and the secondary piston slide. The magnet is pushed by a compression spring housed at the bottom of the drill hole and acting in the direction opposite that in which the master cylinder is actuated for braking.

The magnet, housed in a support affixed to the end of a rod, exits the drill hole and encounters a stop joined to the end of the primary piston extending beyond the master-cylinder borehole. The rod is guided in a sleeve forming a slide bearing affixed to the end of the drill hole.

A Hall sensor on the outside of the master-cylinder housing detects the position of the magnet at rest and controls the activation of the stoplights when the rod, pushed by the activated piston stop, leaves its rest position while compressing the return spring. This spring pushes the magnet into rest position whenever the thrust exerted by the primary piston of the master cylinder on the rod disappears.

A drawback of this master cylinder is that it is relatively complicated because of its structure and its operation. It is affected by the accumulation of dirt in the drill hole in which the magnet slides. If the magnet gets stuck, the situation will be interpreted at the output as activation of the brake, in such a way that the stoplights will remain completely illuminated permanently and no longer be capable of indicating a braking action to the driver that follows.

Another drawback of this master cylinder is that not only is the structure fragile because of the stoplight switch but it is also complex due to this switch, and slow to indicate that stoplight activation has ceased.

An object of the present invention is to provide a master cylinder equipped with a stoplight switch for braking, which is of simple construction and enables efficient and reliable switching to activate stoplights and to turn them off when the brake system returns to rest position.

### SUMMARY

An object of the present invention is to provide a master cylinder with a stoplight control that comprises a translationally integral moving assembly at the extremity of the primary piston and having a bracket removably affixed to the extremity of the primary piston exiting the housing of the master cylinder and a rod whose axis is parallel to the axis of the drill hole, connected to a foot on the bracket and whose extremity, engaged in the drill hole, holds a magnet to cooperate with the Hall sensor.

An example master cylinder according to the present invention may have the advantage of being especially simple to produce by assembling a reduced number of components, ensuring the reliability of detecting brake activation and reducing the response time for activation and stopping. In the event of a fault, it can be easily replaced because it is simply clipped to the primary piston in such a way that the entire assembly with the magnet can be easily removed from the master cylinder for replacement without having to carry out any special adjustment.

According to another characteristic, the bracket is affixed to the rear of the primary piston exiting the master-cylinder housing by a connector that is free to rotate around the axis of the piston and the borehole.

This connector, which is free to rotate around the piston axis, simplifies the realization of the bracket through its attachment and through the guide for the magnet-bearing rod in the drill hole.

According to another characteristic, the bracket is formed by a ring equipped with tongues terminated by exterior hooks forming a crown of retainer hooks, and the inside rear extremity of the primary piston skirt has an internal groove whose cross-section complements that of the hooks carried by the tongues to exert at least a tractive force on the rod through the active movement of the piston in the braking direction.

According to another characteristic, the hooks have a trapezoidal section with a straight rear side, a forward stop surface, and an incline directed frontward and toward the axis, and the groove of the rear extremity of the sleeve forming the skirt of the primary piston has a cross-section homologous to that of the hooks, with a rear stop surface, a forward stop surface, and an incline oriented toward the front, toward the axis, as well as a groove bottom.

The trapezoidal form of the cross-section of the hooks and groove has the advantage of bringing about a connection that has very little play in the tractive direction as well as in the thrust direction, thereby allowing precise control of the stoplights.

According to another characteristic, the foot to which is attached the head of the rod aligned with the axis of the drill hole and which is also parallel to the axis of the borehole, this lateral foot is integral with the ring.

According to another characteristic, the components of the moving assembly are of plastic.

The example master cylinder equipped with a stoplight switch according to the present invention is of particularly simple realization, reliable, and occupies little space.

### BRIEF DESCRIPTION OF THE DRAWINGS

The present invention is described in greater detail below using an embodiment of a tandem master-cylinder as shown in the figures.

FIG. 1 is a cutaway of a tandem master cylinder at the primary piston and, partly, the secondary piston.

FIG. 2 is an axial view of the rear of the primary piston and the hooking of the movable element.

FIG. 3 is a cutaway revealing the forms and dimensional relations of the cutaway of FIG. 2.

### DETAILED DESCRIPTION OF EXAMPLE EMBODIMENTS

By convention, the front of the master cylinder is referred to herein as AV and the rear as AR, corresponding to the position of the primary piston and the actuator that controls it, according to the customary arrangement of the elements of a master cylinder, not shown.

The following description applies to a tandem master cylinder and, under the same conditions, to a simple master cylinder.

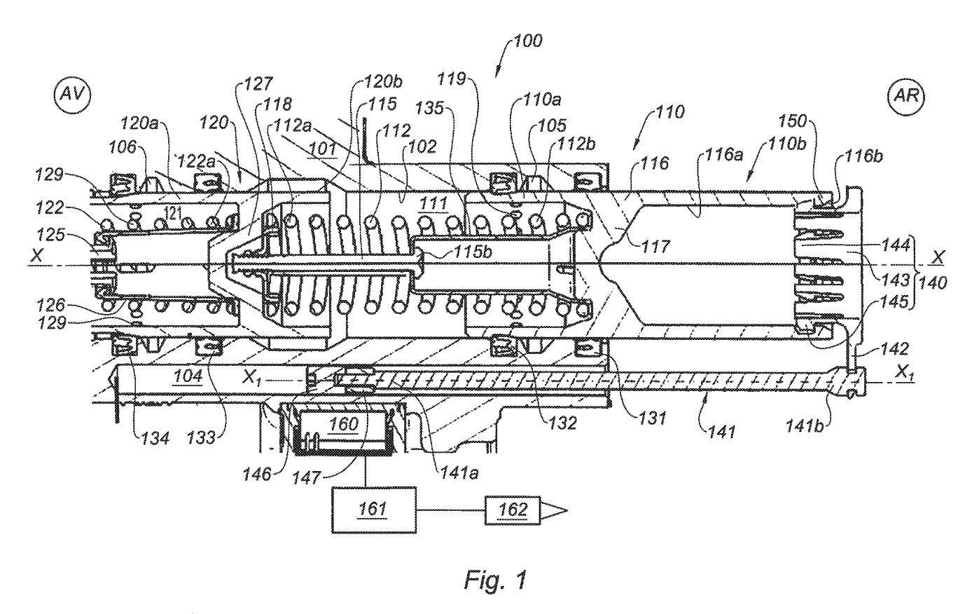

FIG. 1 is a partial cutaway of tandem master cylinder 100 showing, in its housing 101, borehole 102, accommodating primary piston 110 and secondary piston 120, together with their seals 131-134. Primary piston 110 pushes secondary piston 120. Primary piston 110 delimits primary chamber 111 with respect to secondary piston 120. Secondary piston 120 delimits secondary chamber 121 at the end of borehole 102.

Secondary piston 120 rests against the back of secondary chamber 121 through the intermediary of secondary spring 122 and primary piston 110 rests against secondary piston 120 through primary spring 112.

Retainer rod 125, only partly shown, limits the movement of secondary piston 120 against the thrust of secondary spring 122, and retainer rod 115 limits the extensional movement of primary piston 110 with respect to secondary piston 120 for the precise return of the pistons to rest position with respect to the brake fluid supply openings. The portion of primary piston 110 extending beyond borehole 102 of housing 101 is translationally integral with moving assembly 140, formed by a rod whose rear extremity 141b is connected to foot 142 of ring 143, integral with the rear of primary piston 110.

The front extremity 141a of rod 141 bears magnet 147. Housing 101 has drill hole 104 with axis X1X1 parallel to axis XX of borehole 102 of master cylinder 100, and accommodates the extremity of rod 141 with magnet 147.

Hall sensor 160 is attached to housing 101, facing the rest position of forward end 141b of rod 101, with its magnet 147, to detect movement of the rod associated with primary piston 110 in order to detect a braking action. Hall sensor 160 is connected to circuit 161, which controls stoplights 162.

Primary piston 110 consists of cylindrical sleeve 116, subdivided by divider 117 into forward portion 110b and rear portion 110a, which are open.

On the rear side, divider 117 has centering cavity 118 for the head of the pushrod actuated by the braking amplifier. Rear extremity 112a of return spring 112, which surrounds guide sleeve 135, rests against divider 127. Guide sleeve 135 has a rear part crossed by rod 115, held by its expanded head 115b; its front extremity 115a is attached to washer 118, which serves as a support for spring 112 and against which divider 127 of secondary piston 120 also rests. Secondary piston 120 is a cylindrical sleeve, 126, subdivided by divider 127, leaving forward part 120b and rear part 120a open, each of them accommodating one end of a return spring (primary spring 112, secondary spring 122).

Primary piston 110 and secondary piston 120 each have a drilled crown 119, 129 for supplying brake fluid from the brake fluid reservoir and through distribution grooves 105, 106 of the master cylinder housing. Grooves 105, 106 are isolated by seal cups 131-134 resting upon sleeve 116 of primary piston 110 and sleeve 126 of secondary piston 120 to supply chambers 111, 121 of the tandem master cylinder in rest position and then to isolate the two chambers, 111, 121, once the primary piston is pushed.

Moving assembly 140, described in general above, consists of ring 143 bearing tongues 144 terminated by external hooks 145 engaged in the open rear extremity of primary piston 110. The interior of its cylindrical sleeve, 116, is equipped with groove 150 having a truncated trapezoidal cross-section, forming an anchoring lip.

Ring 143 bears foot 142, to which is attached rear extremity 141b of rod 141, whose front extremity, 141a, has guide piece 146, retaining sleeve-shaped magnet 147. Rod 141, engaged in drill hole 104, is guided by piece 146. The length of rod 141 is such that at rest (absence of braking action) magnet 147 is opposite sensor 160, which thereby detects its rest position through the housing. Once magnet 147, displaced by piston 110, leaves its position opposite sensor 160, the operating circuit detects this movement as the onset of braking, triggering the stoplights.

The connector, integral in translation in both directions between ring 143 and primary piston 110, is attached with clips to transmit the piston's translational movement. This connector is rotationally free so that rod 141 remains aligned along axis X1X1 of drill hole 104. Thus, primary piston 110 cannot exert any thrust on rod 141, which remains on its axis X1X1.

The hooking/clipping of ring 143 by means of hooks 145 in groove 150 is realized by means of the trapezoidal cross-section of hooks 145, whose right side rests against right edge 151 of the groove, this right edge being oriented perpendicularly to axis XX. Thus, primary piston 110 precisely pulls rod 141 and its magnet, 147, if the brake is activated.

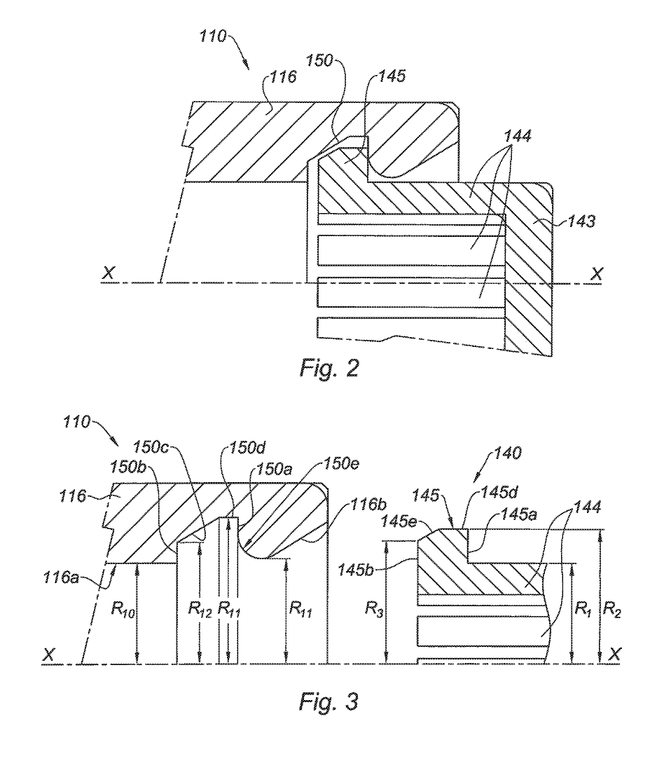

FIG. 2 illustrates, in greater detail, the realization of moving assembly 140 associated with (primary) piston 110, the illustration being limited to the half-section of ring 143 and rear extremity 116b of sleeve 116 of piston 110. The section of hook 145 is shaped like a rectangular trapezoid and groove 150 of sleeve 116 also has a corresponding rectangular trapezoidal section.

Tongues 144 of ring 143 terminate in hooks 145 having rear side 145a, which is straight and perpendicular to axis XX, and in front, stop surface 145b, which is extended by incline 145c, trapezoidal in shape, having short side 145d.

Groove 150, which has a homologous trapezoidal section, has right rear side 150a, perpendicular to axis XX and forward stop surface 150b. Rear surface 150a forms a stop connecting interior shape 116a of sleeve 116 with short incline 150a, preceding stop surface 151, to promote the clipping of hooks 145 in groove 150. Stop surface 150b is extended by incline 150c and groove base 150d.

Rear opening 116b of sleeve 116 has an incline shape to promote the engagement of hooked crown 145 with sleeve 116.

FIG. 3 shows the dimensional relations among the characteristic radii of ring 143:
outside radius R1 of tongued crown 144;
outside radius R2 of rear stop surface 145a of hooks 145;
outside radius R3 of forward stop surface 145b and those on the rear of sleeve 116:
   radius R10 of inside surface 116a of sleeve 116;
   radius R11 of groove base 150 and rear stop surface 150a;
   outside radius R12 of forward stop surface 150b.

### Thus:

radius R1 of tongued crown 144 is slightly less than radius R10;
radius R2 of rear stop surface 145a is slightly less than radius R11;
radius R3 is greater than radius R10 but less than radius R12.

Moving assembly 140, formed of rod 141, foot 142, and ring 143, with its tongues 144 and hooks 145, is an assembly preferably made of injected plastic.

What is claimed is:

1. A master cylinder, comprising:
a primary piston;
a housing equipped with a borehole accommodating the primary piston, the primary piston extending beyond the borehole, wherein the housing, equipped with a stoplight control, has a drill hole whose axis is parallel to that of the borehole accommodating the primary piston, the drill hole accommodating a magnet whose movement is coupled to that of the primary piston; and
a Hall sensor outside the housing, to detect the movement of the magnet to control the stoplights;
wherein the stoplight control includes a moving assembly translationally integral with the primary piston and connected to an end of the primary piston that exits the housing, the stoplight control having a bracket removably affixed to the end of the primary piston that exits the housing, and a rod, whose axis is parallel to the axis of the drill hole, connected to a foot of the bracket and an end of the rod being engaged in the drill hole and bearing a magnet that cooperates with the Hall sensor.

2. The master cylinder according to claim 1, wherein the bracket is attached to a rear of the primary piston exiting the housing of the master cylinder by a connector that is free to rotate around the axis of the piston and the borehole.

3. The master cylinder according to claim 1, wherein the bracket is formed of a ring connected to the foot and equipped with tongues that terminate in outside hooks of trapezoidal section forming a hooked retainer crown, and an inside rear end of a sleeve of the primary piston has an internal groove of trapezoidal section that complements that of the hooks carried by the tongues to exert a tractive effort on the rod through active motion of the piston in a direction of braking.

4. The master cylinder according to claim 3, wherein the hooks have a trapezoidal section with a right rear side, a front stop surface, and an incline directed toward the front, toward the axis of the borehole, and the groove in the rear of the sleeve of the primary piston has a section homologous to that of the hooks, with a rear stop surface, a front stop surface, and an incline oriented to the front, toward the axis of the borehole, as well as a groove base.

5. The master cylinder according to claim 3, wherein the ring has a lateral foot to which is attached a head of the rod aligned with the axis of the drill hole.

6. The master cylinder according to claim 1, wherein the moving assembly is realized of plastic components.
